(19) United States
(12) Patent Application Publication
(10) Pub. No.: US 2008/0025746 A1
(43) Pub. Date: Jan. 31, 2008

(54) IMAGE HEATING APPARATUS

(75) Inventor: Dai KANAI, Abiko-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/782,964

(22) Filed: Jul. 25, 2007

(30) Foreign Application Priority Data
Jul. 27, 2006 (JP) 2006-204661

(51) Int. Cl. G03G 15/20; G03G 21/20

(52) U.S. Cl. 399/69; 399/92

(57) ABSTRACT

An image heating apparatus includes a heating rotatable member for heating an image on the recording material in a nip; and a first fan and a second fan for cooling one and the other and portions of said the heating rotatable member with respect to a rotational axis of said the heating rotatable member, respectively, wherein rotational directions of said first fan and said second fan are opposite from each other.

### FIELD OF THE INVENTION AND RELATED ART

The present invention relates to an image heating apparatus for heating an image on recording medium. As an image heating apparatus to which the present invention is applicable, a fixing apparatus for fixing an unfixed image on recording medium, a glossiness increasing apparatus for heating a fixed image on recording medium to increase the image in glossiness, can be listed, for example.

An image forming apparatus employing an image heating apparatus, such as the above described one, forms an unfixed toner image on a sheet of recording medium (recording paper) with the use of an image forming means, and then, fixes the unfixed toner image to the recording medium to create a permanent image.

There have been proposed various fixing methods for a fixing means. However, commonly used as a fixing mean is a fixing apparatus of the heat-and-pressure type, that is, a fixing apparatus which uses heat and pressure to fix a toner image. This type of fixing apparatus has a rotational heat applying member (heat roller, heat belt, etc.) and a rotational pressure applying member (pressure roller, pressure belt, etc.). The rotational heat applying member is heated by a heating means. The rotational pressure applying member is kept pressed against the heat applying member, forming a fixation nip. In operation, the two rotational members are rotated, and a sheet of recording medium bearing an unfixed toner image is introduced into the fixation nip. As the sheet of recording medium is conveyed through the fixation nip while remaining pinched by the two rollers, the unfixed toner image is fixed to the surface of the recording medium by the heat from the rotational heating member and the nip pressure.

However, this type of fixing apparatus suffers from the following problem. That is, when a substantial number of sheets of recording medium which are narrower, in terms of the direction perpendicular to the recording medium conveyance direction, than the widest possible sheet of recording medium, are continuously conveyed for fixation through the fixing apparatus, the portion (portions) of the rotational heat applying member, which is outside the path of the narrower sheet of recording medium excessively increases in temperature. This occurs for the following reason. That is, heat is not robbed from the portion (portions) of the rotational heating member, which is outside the recording medium path. Thus, as a substantial number of narrower sheets of recording medium are continuously conveyed through the fixation nip of the fixing apparatus, heat accumulates in this portion (these portions) of the rotational heat applying member.

This phenomenon is referred to as “collateral temperature increase” or “out-of-sheet-path temperature increase”. If this collateral temperature increase is excessive, hot offset and/or the thermal deterioration of the structural components of a fixing apparatus, is likely to occur.

As the means for preventing the temperature increase of the out-of-sheet-path, there is the structural arrangement proposed in Japanese Laid-open Patent Applications H04-51179 and 2001-201979, for example. According to these applications, a fixing apparatus is provided with a fan, and the temperature increase is prevented by blowing air on the portion (portions) of the heat applying roller and the portion (portions) of the pressure applying roller, which are outside the sheet path.

More specifically, in the case of Japanese Laid-open Patent Applications H04-51179 and 2001-201979, the fixing apparatus is structured so that when recording medium is introduced into, and conveyed through, the fixing apparatus, the centerline of the recording medium coincides with the centerline of the fixing apparatus. Further, the fixing apparatus is provided with a pair of the combination of a cooling fan and a duct, as a forced draft cooling means. Thus, the temperature increase of the out-of-sheet-path portions of the heat applying roller is prevented by cooling the portions by sending cooling air to these portions.

Further, in the case of Japanese Laid-open Patent Application H04-51179, in order to set the cooling range of the cooling means, in terms of the lengthwise direction of the fixing apparatus, in accordance with the recording medium sheet size, the fixing apparatus is provided with a shutter for adjusting the cooling range of the cooling means.

However, the structural arrangement for the fixing apparatus, such as the above described ones, suffers from the following problem. That is, in reality, the out-of-sheet-path portion of the heat applying roller, which corresponds to one of the lengthwise ends of the heat applying roller and is cooled by its own forced draft cooling means, and that which corresponds to the other lengthwise end and is cooled with its own forced draft cooling means, are not the same in temperature distribution.

As one of the primary reasons for the abovementioned problem, it is possible to list the difference between the pair of forced draft cooling means, in terms of the swirling air flow generated by an axial flow fan, which continuously sends out compressed air by the rotation of its blades, the shape of the duct as a guiding means for guiding the air sent by the cooling fan to the out-of-sheet-path portion of the heat applying roller, etc.

The difference in temperature distribution between one of the out-of-sheet-path portions of the heat applying roller and the other makes different in temperature the two portions of the heat applying member, which correspond to the two edge portions of the recording sheet path. As a result, an image is unsatisfactorily fixed. Further, the abovementioned difference in temperature distribution makes the lengthwise end portions of the pressure applying roller different in the amount of thermal expansion, creating the problem that while a sheet of recording medium is conveyed through a fixing apparatus, the sheet deviates in the direction parallel to the axial line of the pressure applying roller, or the like.

FIG. 16 is a schematic drawing for describing the problems which a cooling system, in accordance with the prior art, employed by a fixing apparatus suffers. FIGS. 16(1) and 16(2) show forced draft cooling means of Type A and Type B, respectively, having a cooling fan 101 and a duct 102. In both the forced draft cooling means of Type A and Type B, the cooling fan 101 is an axial flow fan. Designated by a referential letter a is the air outlet of the duct 102, which faces one of the out-of-sheet-path portions of the heat applying roller 103 shown in FIG. 6(3).

In the case of the forced draft cooling means of Type A, the duct 102 which guides the air flow generated by the axial flow fan 101 to the out-of-sheet-path portion of the heat applying roller is symmetrically shaped with respect to the axial line of the axial flow fan 101.

In the case of the forced draft cooling means of Type B, the duct 102 which guides the air flow generated by the axial flow fan 101 to the out-of-sheet-path portion of the heat applying roller is asymmetrically shaped with respect to the axial line of the axial flow fan 101.

Referring to FIG. 6(3), a line O-O is the rotational axis of the heat applying roller 103. An arrow mark Y designates the rotational direction of the heat applying roller 103. A referential letter S designates a referential centerline for sheet conveyance (hypothetical line), of the recording medium conveyance passage of the fixing apparatus. Designated by a letter Q is the path of a small sheet of recording medium, and designated by referential letter combinations Ra and Rb are the two out-of-sheet-path portions of the recording medium passage of the fixing apparatus, which occur when a small sheet of recording medium is conveyed through the fixing apparatus.

In the case in which both of the two forced draft cooling means for the out-of-sheet-path portions Ra and Rb, one for one, are of Type A, the draft velocity distribution at the air outlet a of the duct of each of both draft air cooling means is as indicated by V-A, for example. In this case, both the out-of-sheet-path portions Ra and Rb are the same in draft velocity distribution. In other words, they may be said to be symmetrical in terms of draft velocity with respect to the referential centerline S.

However, in the case in which the two forced draft cooling means for the out-of-sheet-path portions Ra and Rb, one for one, are of Type B, the draft velocity distribution at the air outlet a of the duct of each of both draft air cooling means is as indicated by V-B, for example, because the amount of the air draft loss caused by the duct wall surface is affected by the duct wall angle. In this case, therefore, the two out-of-sheet-path portions Ra and Rb are asymmetrical in draft velocity distribution with respect to the referential centerline S. Therefore, the two out-of-sheet-path portions Ra and Rb become different in temperature distribution.

In recent years, demand has been increasing for a smaller fixing apparatus. As a result, the duct has been reduced in length, and also, it has become difficult to design a fixing apparatus so that its ducts are symmetrical.

Further, even if the duct 102 of the draft air cooling means for the two out-of-sheet-path portions Ra and Rb is symmetrically shaped with respect to the axial line of the axial flow fan 101, as in the case of the draft air cooling means of Type A, their cooling ranges become asymmetrical with respect to the referential center line S, in terms of their cooling effects upon the corresponding out-of-sheet-path portions Ra and Rb. That is, the heat applying roller 103 rotates in the direction indicated by the arrow mark Y. Thus, in the case in which the two forced draft cooling means for the two out-of-sheet-path portions Ra and Rb, one for one, are the same in the direction in which the blades of their axial flow fans 102 rotate, but, are asymmetrical in the line of flow of the draft, the line of flow of the cooling air coming out of draft outlets a and a of the two ducts is affected by the rotating heat applying roller 103. Consequently, the body of cooling air which flows along (around) the out-of-sheet-path portion Ra and the body of cooling air which flows along (around) the out-of-sheet-path portion Rb become asymmetrical in terms of line of flow, and therefore, becoming asymmetrical in terms of cooling effect and range, with respect to the referential center line S.

Therefore, the portion of one of the two out-of-sheet-path portion of the heat applying roller 103, which corresponds to the area next to one of the lateral edges of the sheet path Q, becomes different in temperature from the portion of the other out-of-sheet-path portion of the heat applying roller 103, which corresponds to the other lateral edge of the sheet path Q. As a result, the problem that an image is unsatisfactorily fixed is likely to occur. Further, the two out-of-sheet-path portions of the pressure applying roller also become different in the amount of thermal expansion. Therefore, the problem that while a sheet of recording medium is conveyed through the fixing apparatus, it deviates in the direction parallel to the axial line of the pressure applying roller, or the like problem, is likely to occur.

In recent years, colorization has occurred in the field of an image forming apparatus. Therefore, a fixing apparatus is required to be very accurate in fixation temperature. Therefore, it is required to solve the problem described above. Further, the above described problem is required to be solved also from the standpoint of providing a reliable high speed image forming apparatus (fixing apparatus).

### SUMMARY OF THE INVENTION

The primary object of the present invention is to provide an image heating apparatus capable of properly cooling the lengthwise end portions of its rotational heating member in terms of the direction parallel to the rotational axis of the heating member.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic cross sectional view of the fixing apparatus in the first preferred embodiment of the present invention.

FIG. 2 is a schematic exploded perspective view of the fixing mechanism portion and forced draft cooling mechanism of the fixing apparatus.

FIG. 3 is a schematic and partially cutaway front view of the fixing mechanism portion of the fixing apparatus.

FIG. 4 is a schematic vertical sectional view of the fixing mechanism portion of the fixing apparatus.

FIG. 5 is an exploded perspective view of the forced draft cooling mechanism portion of the fixing apparatus.

FIG. 6 is a schematic sectional view of the forced draft cooling mechanism portion, showing the state of the cooling mechanism when small sheets of recording medium are continuously conveyed through the fixing apparatus.

FIG. 7 is a schematic sectional view of the forced draft cooling mechanism portion, showing the state of the cooling mechanism when medium sheets of recording medium are continuously conveyed through the fixing apparatus.

FIG. 8 is a schematic sectional view of the forced draft cooling mechanism portion, showing the state of the cooling mechanism when large sheets of recording medium are continuously conveyed through the fixing apparatus.

FIG. 9 is a block diagram of the control system of the fixing apparatus.

FIG. 10 is a cross-sectional view of the image forming apparatus in the first preferred embodiment of the present invention.

FIG. 11 is a schematic external perspective view of the fixing apparatus in the second preferred embodiment of the present invention.

FIG. 12 is a schematic cross-sectional view of the fixing apparatus shown in FIG. 11.

FIG. 13 is a schematic sectional view of the forced draft cooling mechanism portion, showing the state of the cooling mechanism when small sheets of recording medium are continuously conveyed through the fixing apparatus.

FIG. 14 is a schematic sectional view of the forced draft cooling mechanism portion, showing the state of the cooling mechanism when medium sheets of recording medium are continuously conveyed through the fixing apparatus.

FIG. 15 is a schematic sectional view of the forced draft cooling mechanism portion, showing the state of the cooling mechanism when large sheets of recording medium are continuously conveyed through the fixing apparatus.

FIG. 16 is a schematic drawing of a typical conventional forced draft cooling mechanism for a fixing apparatus.

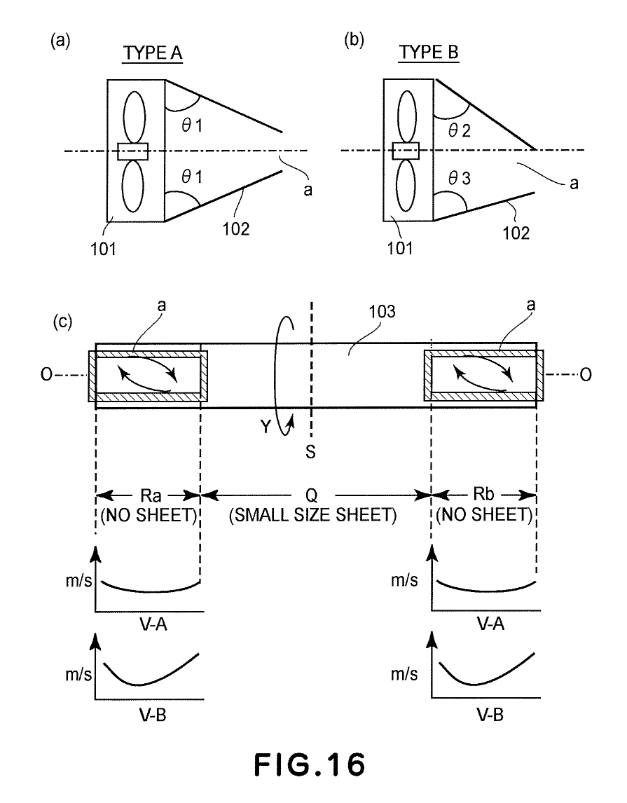

### DETAILED DESCRIPTION OF THE PREFERRED EMBODIMENTS

Hereafter, the preferred embodiments of the present invention will be described with reference to the appended drawings. However, the following embodiments are not intended to limit the present invention in scope.

### Embodiment 1

### (1) Image Forming Portion

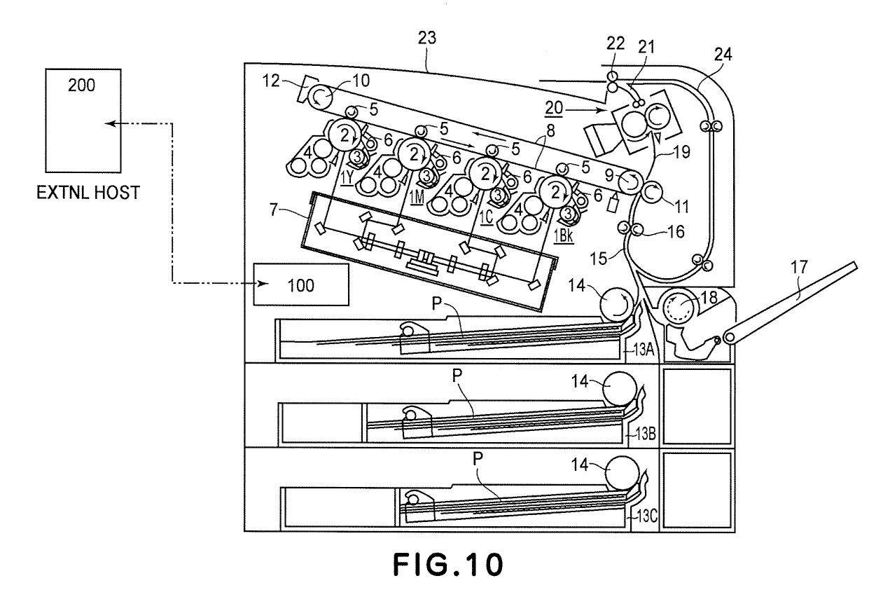

FIG. 10 is a schematic vertical sectional view of an electrophotographic color printer as an example of an image forming apparatus having an image heating apparatus, as its fixing apparatus, in accordance with the present invention, and shows the general structure of the printer. First, the general structure of the image forming portion of the printer will be described.

This printer can form a full-color image on recording medium; it can output a full color copy in response to picture information inputted from an external host apparatus 200 connected to its control circuit portion 100 (controlling means: CPU) in such a manner that information can be transmitted between the control portion 100 and host apparatus 200.

The external host apparatus 200 is a computer, an image reader, or the like. The control circuit portion 100 exchanges signals with the external host apparatus 200. It also exchanges signals with the various devices of which the printer is made, and controls the image formation sequence carried out by the printer.

Designated by a referential number 8 is a flexible intermediary transfer belt (which hereafter may be referred to simply as belt). The belt 8 is suspended by a pair of rollers 9 and 10, being thereby stretched between the two rollers. The roller 9 is a roller which opposes a secondary transfer roller, with the belt 8 sandwiched between the two rollers. The roller 10 is a tension roller, or the roller which provides the belt 8 with a preset amount of tension. As the roller 9 is driven, the belt 8 is circularly driven at a preset velocity in the counterclockwise direction indicated by an arrow mark. Designated by a referential number 11 is the secondary transfer roller, which is kept pressed against the roller 9, with the presence of the belt 8 between the two rollers, as described above. The interface between the belt 8 and secondary transfer roller 11 makes up the secondary transfer portion.

Designated by references 1Y, 1M, 1Y, and 1Bk are first-fourth image forming portions, which are juxtaposed under the belt 8, in a straight line and in parallel to the belt movement direction, with preset intervals. Each image forming portion is an electrophotographic image forming portion, and employs a laser-based exposing method. Each image forming portion has an electrophotographic photosensitive member 2, as an image bearing member, which is in the form of a drum (which therefore will be referred to simply as drum hereafter). The drum 2 is rotationally driven in the clockwise direction indicated by an arrow mark at a preset peripheral velocity. Each image forming portion is also provided with a primary charging device 3, a developing device 4, a transfer roller 5 as a transferring means, and a drum cleaning apparatus 6, which are arranged in the adjacencies of the peripheral surface of the drum 2. The transfer roller 5 is on the inward side of the loop which the belt 8 forms, and is kept pressed against the drum 2, with the portion of the belt 8, which is moving through the bottom half portion of the belt loop, sandwiched between the transfer roller 5 and drum 2. The interface between the drum 2 and belt 8 makes up the primary transfer portion. Designated by a referential number 7 is a laser-based exposing apparatus, which is for exposing the drum 2 in each image forming portion. The exposing apparatus 7 is made up of a laser, a polygon mirror, a deflection mirror, etc. The laser emits a beam of laser light in response to the sequential electrical digital picture signals in accordance with the picture information given to the exposing apparatus.

The control circuit portion 100 controls the image forming operation of each image forming portion in response to picture signals (monochromatic picture signals obtained by color separation) inputted from the external host apparatus 200, forming thereby yellow, magenta, cyan, and black toner images on the peripheral surfaces of the rotating drums 2 in the first-fourth image forming portions 1Y, 1M, 1C, and 1Bk, respectively, with preset control timings. Incidentally, the principles of electrophotography, and the electrophotographic process for forming a toner image on the drum 2, are well-known, and therefore, will not be described here.

After the formation of toner images on the drums 2 in the four image forming portions, one for one, the toner images are sequentially transferred in layers onto the outward surface (in terms of belt loop) of the belt 8, which is being circularly driven at a velocity which matches the rotational speed of each of the four drums 2. As a result, the abovementioned four toner images are placed in layers on the surface of the belt 8, synthetically effecting thereby an unfixed full-color image on the surface of the belt 8.

Meanwhile, the sheet feeder roller 14 of a sheet feeder cassette selected from among sheet feeder cassettes 13A, 13B, and 13C in which large, medium, and small sheets (in terms of width) of recording medium are stored, respectively, and which are vertically stacked, is driven with a preset sheet feeding timing. As the sheet feeder roller 14 is driven, one of the sheets of recording medium P in the selected sheet feeder cassette is separated from the rest of sheets in the cassette, and is fed into the main assembly of the image forming apparatus. Then, the recording medium P is conveyed to a pair of registration rollers 16 through a vertical sheet conveyance path 15. When a manual sheet feeder tray 17 (multipurpose tray) is the means selected for feeding recording medium P into the apparatus main assembly, a sheet feeder roller 18 is driven. As the roller 18 is driven, one of the sheets of recording medium P stacked in the manual sheet feeder tray 17 is separated from the rest of the sheets in the tray, and is fed into the apparatus main assembly. Then, the recording medium P is conveyed to the pair of registration rollers 16 through the vertical sheet conveyance path 15.

The registration rollers 16 convey the recording medium P with such a timing that the leading edges of the abovementioned full-color toner image on the belt 8 (which is being rotated) arrives at the secondary transfer portion at the same time as the leading edge of the recording medium P arrives at the secondary transfer portion. Thus, the four monochromatic toner images (which effect single full-color image) on the belt 8 are transferred together (secondary transfer) onto the surface of the recording medium P, in the secondary transfer portion, as if they are peeled away from the belt 8 starting their leading edges. After being conveyed out of the secondary transfer portion, the recording medium P is separated from the surface of the belt 8, and is guided into a fixing apparatus 20 while being guided by a vertical guide 19. By this fixing apparatus 20, the abovementioned multiple toner images, different in color, on the recording medium P are fixed to the surface of the recording medium P while being mixed. As a result, a permanent solid full-color image is effected on the surface of the recording medium P; a full-color copy is yielded. Then, the recording medium P (full-color copy) is conveyed out of the fixing apparatus 20. Thereafter, the recording medium P (full-color copy) is conveyed through a sheet conveyance path 21, and is discharged into a delivery tray 23 by a pair of sheet discharge rollers 22.

After the separation of the recording medium P from the belt 8 in the secondary transfer portion, the surface of the belt 8 is cleaned by the belt cleaning apparatus 12; the residues, such as the toner particles, remaining on the belt 8 after the secondary transfer, are removed by the belt cleaning apparatus 12 so that the belt 8 can be repeatedly used for image formation.

When the image forming apparatus is in the black-and-white printing mode, only the fourth image forming portion 1Bk, which is the portion for forming a black toner image, is operated under the control of the control circuit portion 100. When the image forming apparatus is in the two-sided printing mode, the recording medium P is conveyed in the direction to be discharged into the delivery tray 23 by the discharge rollers 22 until the trailing end of the recording medium P almost moves past the interface between the pair of discharge rollers 22, after the printing of an image on the recording medium P. Then, immediately before the trailing end of the recording medium P moves past the sheet discharge rollers 22, the rollers 22 are reversed in rotation. Thus, the recording medium P is introduced into a re-feeding path 24. Then, it is conveyed through the re-feeding path 24 to be conveyed again to the registration rollers 16, being thereby placed upside down. Thereafter, the recording medium P is conveyed through the secondary transfer portion and fixing apparatus 20 as it was when an image was printed on the first surface. Then, the recording medium P is sent out as a two-sided copy, onto the delivery tray 23.

### (2) Fixing Apparatus 20

In the following description of the fixing apparatus 20, the “lengthwise direction” of the fixing apparatus 20 and the components thereof mean the direction parallel to the direction perpendicular to the recording medium conveyance direction. The “front side” of the fixing apparatus 20 means the lateral side of the fixing apparatus 20, from which the recording medium P is introduced into the fixing apparatus 20, and the “left” or “right” side of the apparatus means the left or right side of the apparatus as seen from the front side of the apparatus. The “width” of a sheet of recording medium means the measurement of the sheet in terms of the direction perpendicular to the recording medium conveyance direction.

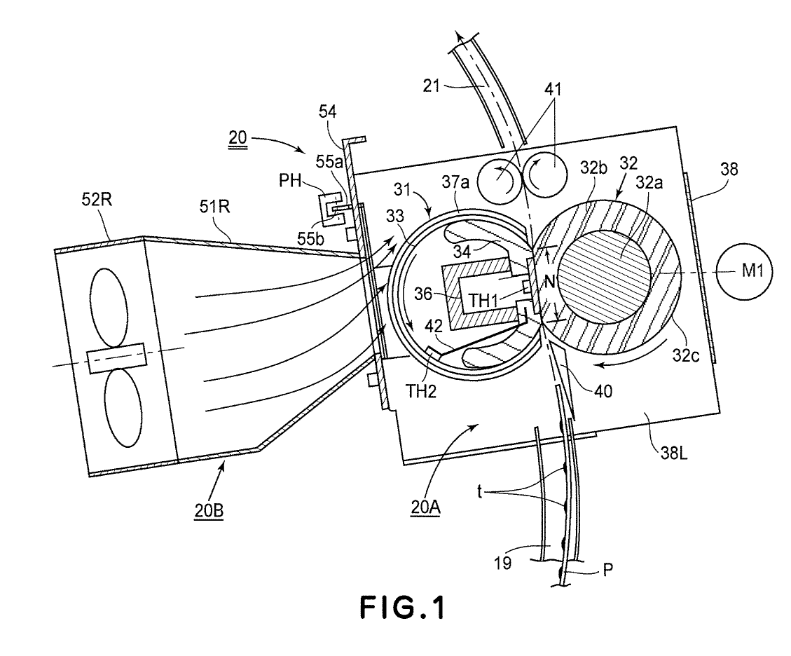

FIG. 1 is an enlarged schematic cross-sectional view of the fixing apparatus 20 of the image forming apparatus shown in FIG. 10. The fixing apparatus 20 is roughly separable into a fixing mechanism portion 20A, and a forced draft cooling mechanism portion 20B. The fixing mechanism portion 20A employs a heating belt. The cooling mechanism portion 20B uses forced draft of air as cooling medium.

### (2-1) Fixing Mechanism Portion 20A

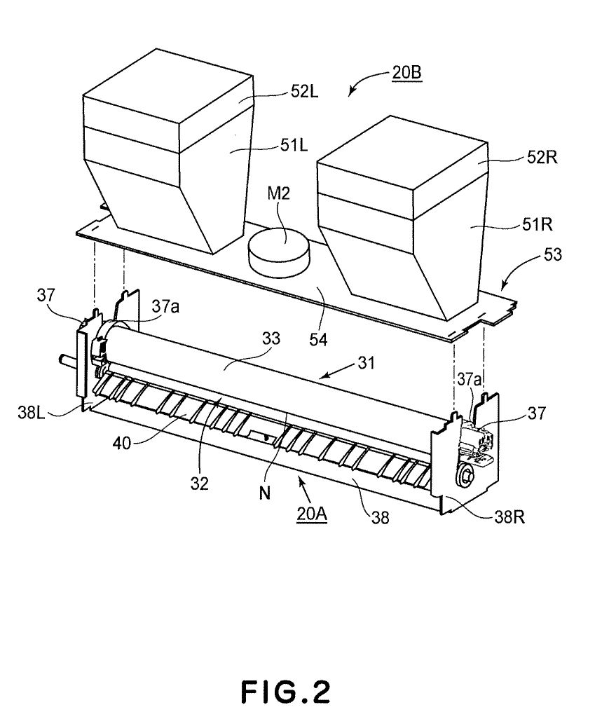

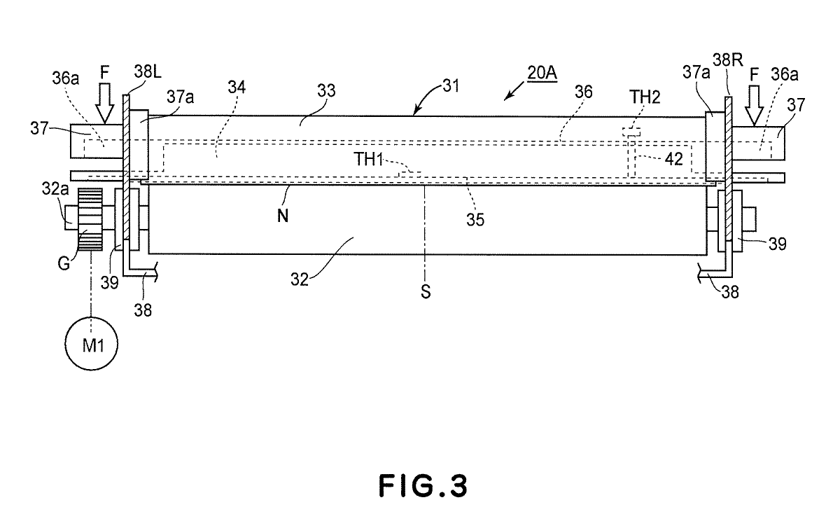

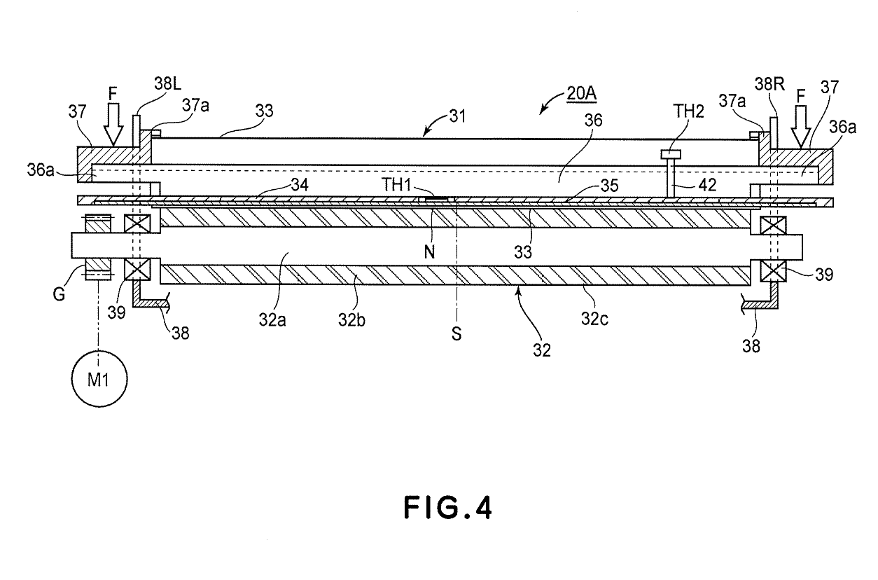

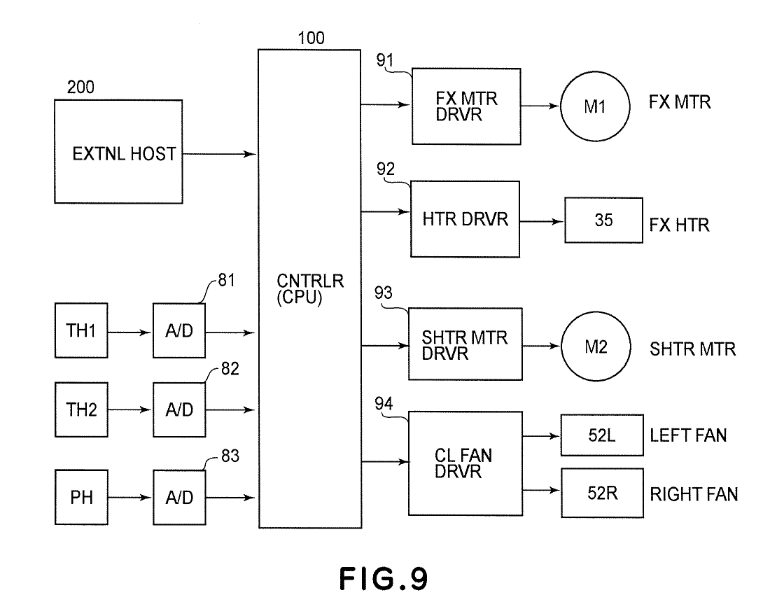

First, referring to FIGS. 1-4, and 9, the general structure of the fixing mechanism portion 20A will be described. FIG. 2 is an exploded perspective view of the combination of the fixing mechanism portion 20A and forced draft cooling mechanism portion 20B. FIG. 3 is a schematic front view of the combination of the fixation belt assembly and pressure application roller of the fixing mechanism portion 20A. FIG. 4 is a vertical sectional view of the combination of the fixation belt assembly and pressure applying roller (which hereafter will be referred to simply as pressure roller), shown in FIG. 2, at a plane which coincides with the axial line of the pressure roller. FIG. 9 is a block diagram of the control system of the fixing apparatus 20.

Basically, the fixing mechanism portion 20A is identical to the fixing apparatus disclosed in Japanese Laid-open Patent Applications H04-44075-44083, H04-204980-204984, etc. It is a fixing apparatus of the on-demand type, and employs the heating belt (heating film). Further, this fixing apparatus employs a pressure applying rotational member (pressure roller, for example) to circularly drive the belt; it is of the tension-less type.

Designated by a referential number 31 is a fixation belt assembly, and designated by a referential number 32 is an elastic pressure roller, which is a pressure applying rotating member (nip formation member). The fixation belt assembly 31 and pressure roller 32 are kept pressed against each other to form a fixation nip N.

Designated by a referential number 33 is a fixation belt of the fixation belt assembly 31, which is a circularly movable member for heat application. The fixation belt 33 is cylindrical; it is endless and in the form of a sleeve. It is flexible. Designated by a referential number 34 is a belt guiding member (which hereafter will be referred to simply as guiding member), which is heat resistant and rigid. The guiding member 34 is in the form of a trough, and is semicircular in cross section. Designated by a referential number 35 is a ceramic heater (which hereafter will be referred to simply as heater) as a heat source (heating member). The guiding member 34 is provided with a groove, which is in the outwardly facing surface of the guiding member 34 and extends in the lengthwise direction of the guiding member 34. The heater 35 is fitted in this groove of the guiding member 34, being thereby solidly attached to the guiding member 34. The fixation belt 33 is loosely fitted around the guiding member 33 fitted with the heater 35. Designated by a referential number 36 is a pressure application stay (which hereafter will be referred to simply as stay). The stay 36 is rigid, and is U-shaped in cross section. It is on the inward side of the guiding member 34. Designated by a pair of alphanumeric references 36a are a pair of arm portions extending outward from the left and right lengthwise ends of the stay 36, one for one. Designated by a pair of referential numbers 37 are a pair of end holders in which the arm portions 36a are fitted, one for one. Designated by reference 37a is a flange portion, which is an integral part of the end holder 37.

Ordinarily, the fixation belt 33 is a laminar belt, and is made up of a base layer, an elastic layer, a release layer, etc. The base layer is formed of heat resistant resin or metal. The fixation belt 33 is thin and flexible. It is high in thermal conductivity, and is low in thermal capacity.

The ceramic heater 35 is a linear heating member. It is low in thermal capacity. It is attached to the guiding member 35 so that it extends in the direction perpendicular to the moving direction of the fixation belt 33 and recording medium P. Basically, it is made up of a substrate and a heat generation layer. The substrate is formed of ceramic, such as aluminum titanate, alumina, or the like. The heat generation layer is formed on the substrate, of silver-palladium, or the like, and generates heat as electric current is flowed through it. There are various ceramic heaters, which are well-known. Thus, the ceramic heater 35 will not be described in detail here.

The pressure roller 32 is made up of a metallic core 32a, and an elastic layer 32b formed around the metallic core 32a, of silicone rubber or the like, to reduce the roller 32 in overall hardness. For the improvement of the surface properties of the pressure roller 32, the peripheral surface of the elastic layer 32b may be coated with a fluorinated resin layer 32c formed of PTFE, PFA, FEP, or the like. The pressure roller 32 is rotatably supported between the left and right lateral plates 38L and 38R of the apparatus frame 38; the left and right end portions of the metallic core 32a are supported by a pair of bearing members 39 with which the left and right lateral plates 38L and 38R are fitted.

The fixation belt assembly 31 is positioned in parallel to the above described pressure roller 32, with the heater side of the fixation belt assembly 31 facing the pressure roller 32. It is kept pressed against the pressure roller 32; the left and right holders 37 are kept pressed with a preset amount of force F generated by an unshown pressure application mechanism, in the direction perpendicular to the axial direction of the pressure roller 32. Thus, the surface of the heater 35 is kept pressed against the pressure roller 32, with the presence of the fixation belt 33 between the heater 35 and pressure roller 32, forming thereby the fixation nip N necessary for thermal fixation. The amount of force F is controlled so that the width of the fixation nip N, in terms of the recording medium conveyance direction, will have a preset value. The pressure application mechanism is provided with a pressure removal mechanism. Thus, when necessary, for example, when dealing with a paper jam or the like, the pressure can be removed to make it easier to remove the jammed recording medium P in the fixation nip N.

Designated by a referential number 40 is an entrance guide attached to the apparatus frame 38, and designated by a referential number 41 is a pair of sheet discharge rollers, which are also attached to the apparatus frame 38. The entrance guide 40 plays the role of guiding the recording medium P so that after the recording medium P is moved past the secondary transfer nip N and is guided into fixing apparatus 20 by the vertical guide 19, it is precisely guided into the fixation nip N.

Designated by a referential letter G is a drive gear solidly attached to one end of the metallic core 32a of the pressure roller 32. It is to this gear G that the rotational force of a fixation motor Ml is transmitted through an unshown driving force transmission mechanism. As the driving force is transmitted to the drive gear G, the pressure roller 32 is rotationally driven in the clockwise direction indicated by an arrow mark in FIG. 1. As the pressure roller 32 is rotationally driven, rotational force is transmitted to the fixation belt 33 by the friction between the outward surface of the fixation belt 33 and the pressure roller 32. As a result, the fixation belt 33 rotates in the counterclockwise direction indicated by an arrow mark, with its inward surface remaining in contact with, and sliding on, the heater 35, on the outward side of the guiding member 34 (pressure roller is driven to circularly move fixation belt 33). The fixation belt 33 circularly moves at a peripheral velocity which is roughly equal to the peripheral velocity of the pressure roller 32. The left and right flange portions 37a catch the belt 33 by the corresponding lateral edges of the fixation belt 33 as the fixation belt 33 deviates in the left or right direction; they control the lateral movement of the fixation belt 33. The inward surface of the fixation belt 33 is coated with grease (lubricant) to ensure that the fixation belt 33 smoothly slides on the heater 35 and guiding member 34.

After the recording medium P is guided into the fixation nip N, it is conveyed through the fixation nip N by the rotation of the pressure roller 32 and fixation belt 33 while remaining pinched by the pressure roller 32 and fixation belt 33. In this embodiment, the recording medium P is conveyed through the fixation apparatus 20 so that the centerline of the recording medium P in the fixing apparatus 20 coincides with the centerline of the recording medium conveyance path, in terms of the lengthwise direction of the fixing apparatus (central alignment). That is, as the recording medium P is guided into the fixing apparatus 20, it is conveyed through the fixing apparatus 20 so that the centerline of the recording medium P coincides with the centerline of the recording medium passage, regardless of the size of the recording medium conveyable through the fixing apparatus 20. Designated by a referential letter S is the referential centerline (theoretical line) of the recording medium passage of the fixing apparatus 20, which coincides with the centerline of the recording medium P when the recording medium P is conveyed through the fixing apparatus 20.

Designated by alphanumeric references TH1 and TH2 are main and subordinate thermistors as first and second temperature detecting means, respectively. In terms of the lengthwise direction of the heater 35, the main thermistor TH1 is placed in contact with the roughly the center of the rear surface of the heater 35 to detect the temperature of the portion of the heater which remains within the recording medium path regardless of recording medium size. The subordinate thermistor TH2 is placed elastically in contact with the inward surface of the fixation belt 33 to detect the temperature of the portion of the fixation belt 33 which corresponds to the portion of the recording medium path, which is outside the path of a recording medium narrower than the path of a widest recording medium conveyable through the fixing apparatus 20. More concretely, the subordinate thermistor TH2 is supported by the free end portion of an elastic thermistor supporting member 42, which is in the form of a leaf spring. The supporting member 42 is fixed to the guiding member 34. In other words, the subordinate thermistor TH2 is kept elastically in contact with the inward surface of the fixation belt 33 by the elasticity of the elastic thermistor supporting member 42.

As electric current is flowed by a heater driver circuit 92 (FIG. 9) through the heat generation layer of the heater 35, which is on the heater substrate, the heat generation layer generates heat. As a result, the heater 35 quickly increases in temperature across the entirety of its effective heat generation range in terms of its lengthwise direction. The temperature of the heater 35 is detected by the main thermistor TH1, and the electrical information regarding this heater temperature is inputted into the control circuit portion 100 through an A/D converter 81. In addition, the temperature of the fixation belt 33 is detected by the subordinate thermistor TH2, and the electrical information regarding this temperature of the fixation belt 33 is inputted into the control circuit portion 100 through an A/D converter 82. The control circuit portion sets up a proper procedure for adjusting the temperature of the fixation heater 35 based on the outputs of the main and subordinate thermistors TH1 and TH2, in order to control the amount of electric power supplied to the fixation heater 35 from the heater driver circuit 92. That is, the temperature of the fixation heater 35 is controlled so that the heater temperature detected by the main thermistor TH1 remains at a preset fixation temperature level.

The control circuit portion 100 starts to rotationally drive the pressure roller 32 by controlling the fixation motor driver circuit 91 in response to a print start signal from the external host apparatus 200, or a control signal other than the print start signal. The control circuit portion 100 also starts to generate heat in the heater 35 by controlling the heater driver circuit 92. As soon as the fixation belt 33 stabilizes in circulatory speed, and the temperature of the heater 35 reaches the preset level, the recording medium P bearing an unfixed toner image t is guided into the fixation nip portion N along the entrance guide 40 from the direction of the image forming portion, with the toner image bearing surface of the recording medium P facing the fixing belt 33. The recording medium P, and the portion of the fixation belt 33, which corresponds to the recording medium P, move together through the fixation nip N, with the recording medium P kept pressed against the heater 35, with the presence of the fixation belt 33 between the heater 35 and recording medium P. While the recording medium P is conveyed through the fixation nip N, the recording medium P is given heat by the fixation belt 33 heated by the heater 35. As a result, the toner image t on the recording medium P is thermally fixed to the surface of the recording medium P. After the conveyance of the recording medium P through the fixation nip N, the recording medium P is separated from the surface of the fixation belt 33, and is conveyed further to be discharged from the apparatus main assembly.

### (2-2) Forced Draft Cooling Mechanism Portion 20B

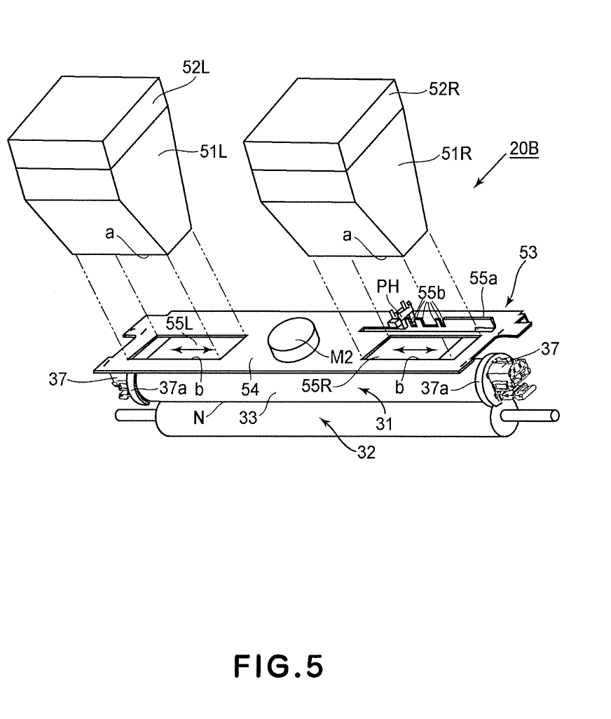

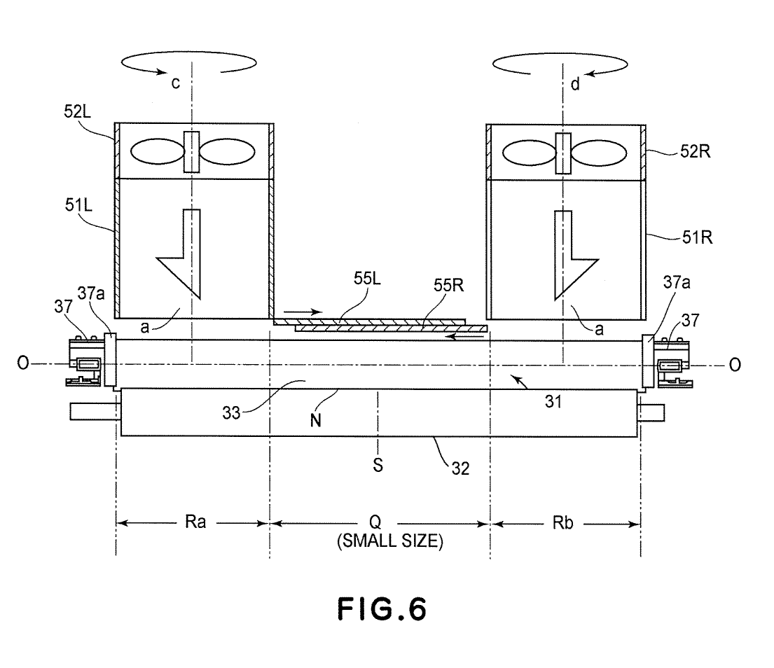

Next, referring primarily to FIGS. 5-8, the forced draft cooling mechanism portion 20B will be described. The forced draft cooling mechanism portion 20B is a cooling means which cools the fixing mechanism portion 20A by sending air thereto. More specifically, as a recording medium, which is narrower than a widest recording medium, is continuously conveyed through the fixing apparatus 20, the portions of the fixing mechanism portion 20A, which are outside the path of the narrower recording medium, are likely to increase in temperature. It is this increase in temperature of the portions of the fixing mechanism portion 20A, which hereafter will be referred to as out-of-sheet-path temperature increase, that the forced draft cooling mechanism 20B prevents by sending air thereto. FIG. 5 is an exploded perspective view of the forced draft cooling mechanism portion 20B. FIGS. 6-8 are schematic drawings of the forced draft cooling mechanism portion 20B, showing the operation of the shutter plates. FIGS. 6-8 show the forced draft cooling mechanism portion 20B, as seen from the downstream side in terms of the recording medium conveyance direction. Thus, the direction, in which a pair of cooling fans 52L and 52R (which will be described later) rotate, is such that air is blown toward the lateral edges of the fixation belt 33, to prevent the air from being blown into the sheet path.

The forced draft cooling mechanism portion 20B is provided with first and second cooling means. The first cooling means is provided with a left duct 51L and a left cooling fan 52L (first fan). The left duct 51L is structured so that its air outlet a faces the left end portion of the fixation belt 33 in terms of the lengthwise direction of the fixation belt 33. The left cooling fan 52L sends the cooling air into the left duct 51L. The second cooling means is provided with a right duct 51R and a right cooling fan 52R (second fan). The right duct 51R is structured so that its air outlet a faces the right end portion of the fixation belt 33 in terms of the lengthwise direction of the fixation belt 33. The right cooling fan 52R sends the cooling air into the right duct 51R. The second cooling means is also provided with a shutter mechanism 53, as an air outlet opening width adjusting means, for adjusting the left and right ducts 51L and 51R in the width of the openings of their air outlets a.

The left and right ducts 51L and 51R are positioned so that their axial lines are roughly perpendicular to the rotational axial line O-O of the fixation belt 33 (FIG. 6). The cooling fans 52L and 52R, as air blowing means, are located on the opposite sides of the left and right ducts 51L and 51R from their air outlets a and a, respectively.

The left and right cooling fans 52L and 52R are axial flow fans. The rotational direction of the blades of the right cooling fan 52R is opposite to that of the left cooling fan 52L. Although the left and right cooling fans 52L and 52R are opposite in the rotational direction of their blades, they are the same in the air flow direction, and also, in performance.

The left and right ducts 51L and 51R are symmetrically shaped with respect to the rotational axes of the fans 52L and 52R, respectively, or with respect to the referential centerline S (centerline of fixation belt 33 in terms of the lengthwise direction) The shutter mechanism 53 has a shutter frame 54, left and right shutter plates 55L and 55R, a shutter motor M2, shutter plate position detecting means 55a, 55b, PH, etc. The shutter frame 54 is provided with left and right holes b and b (windows). The left and right holes b and b of the shutter frame 54 correspond in shape and size to the air outlets a and a of the left and right ducts 51L and 51R, respectively. The left and right ducts 51L and 51R are fixed to a substrate (shutter frame) 54 so that the air outlets a and a of the right ducts 51L and 51R align with the left and right holes b and b of the substrate 54 (shutter frame).

The pair of shutters, that is, the left and right shutter plates 55L and 55L, are located on the opposite side of the substrate 54 (shutter frame) from the side to which the ducts 51L and 51R are fixed. The left shutter plate 55L is movable to adjust the width of the left hole b of the substrate 54 (shutter frame), that is, the width of the opening of the air outlet a of the left duct 51L, whereas the right shutter plate 55R is movable to adjust the width of the right hole b of the substrate 54, that is, the width of the opening of the air outlet a of the right duct 51R. The left and right shutter plates 55L and 55R are connected to each other with an unshown rack-and-pinion mechanism. Thus, as the pinion is rotationally driven forward or in reverse by the shutter motor M2 (pulse motor), the left and right shutter plates 55L and 55R connected to the rack are moved to increase or reduce the width of the openings of the air outlets a and a of the left and right ducts 51L and 51R, respectively, while keeping the two openings equal in width.

For clarity, FIGS. 6-8 show only the left and right ducts 51L and 51R, left and right cooling fans 52L and 52R, and left and right shutter plates 55L and 55R, of the forced draft cooling mechanism portion 20B.

Regarding the size of the sheet recording medium conveyable through the fixing apparatus 20, hereafter, a sheet of recording medium which is the largest in width will be referred to as the large recording paper, and a sheet of recording medium which is the smallest in width will be referred to as the small recording paper. Further, a sheet of recording medium which is the medium in width will be referred to as the medium recording paper.

FIG. 6 is a schematic drawing of the fixing mechanism portion 20A in the state in which a small recording paper is being conveyed through the fixing apparatus 20. In FIG. 6, designated by a referential letter Q is the path of a small recording paper, and designated by referential letter combinations Ra and Rb are the left and right out-of-sheet-path portions of the recording medium passage of the fixing apparatus 20, which are on the left and right sides of the path Q, or the path of a small recording paper. The air outlets a and a of the left and right ducts 51L and 51R correspond to the left and right out-of-sheet-path portions Ra and Rb. The width of the openings of the air outlets a and a of the left and right ducts 51L and 51R are the same as those of the left and right out-of-sheet-path portion Ra and Rb, respectively. Further, when the fixing mechanism portion 20A is in the state shown in FIG. 6, the left and right shutter plates 55L and 55R are in the position in which they leave fully open the air outlets of the left and right ducts 51L and 51R. Thus, the left and right end portions of the fixation belt 33, which correspond to the left and right out-of-sheet-path portions Ra and Rb, that is, the portions of the recording medium passage, which occur when a small recording paper is conveyed through the fixing apparatus 20, are cooled by the cooling air blown onto them through the air outlets a and a of the left and right ducts 51L and 51R, which are fully open. Therefore, the problem that the portions of the fixation belt 33, which correspond to the out-of-sheet-path portions of the sheet conveyance passage, which occur when a small recording paper is conveyed through the fixing apparatus, increase in temperature when a substantial number of small sheets of recording paper are continuously conveyed through the fixing apparatus, is prevented.

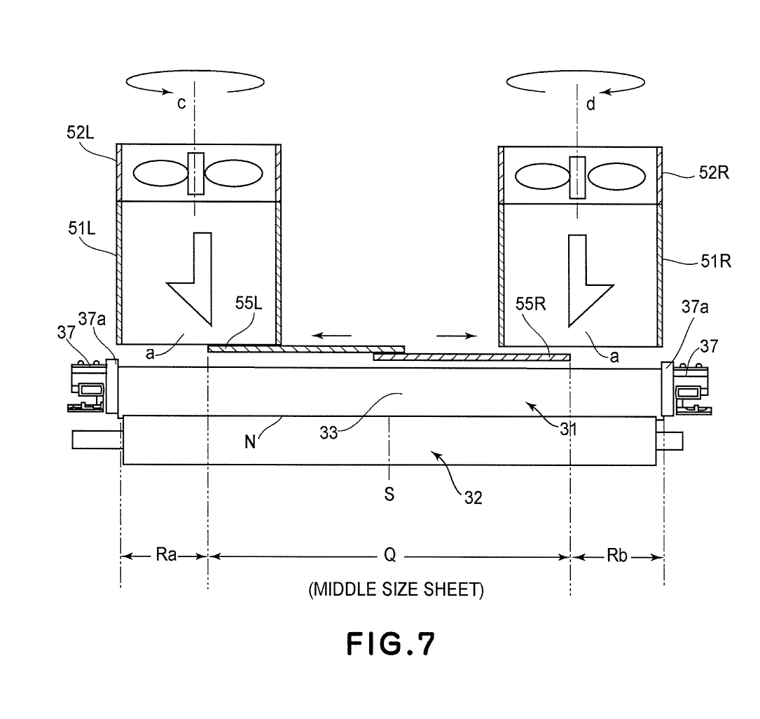

FIG. 7 is a schematic drawing of the fixing mechanism portion 20A in the state in which a medium recording paper is being conveyed through the fixing apparatus 20. In FIG. 7, designated by a referential letter Q is the path of a medium recording paper, and designated by referential letter combinations Ra and Rb are the left and right out-of-sheet-path portions of the recording medium passage of the fixing apparatus 20, which are on the left and right sides of the path Q, or the path of a medium recording paper. The air outlets a and a of the left and right ducts 51L and 51R correspond to the left and right out-of-sheet-path portions Ra and Rb. When medium sheets of recording medium are used as recording medium, the left and right shutter plates 55L and 55R are moved to the positions which were set in accordance with the width of a medium recording paper to reduce the width of the air outlets a and a of the ducts 51L and 51R to the values equal to the widths of the left and right out-of-sheet-path portions Ra and Rb which occur as a medium recording paper is conveyed. Thus, the portions of the fixation belt 33, which correspond to the left and right out-of-sheet-path portions Ra and Rb, that is, the portions of the recording medium passage, which occur when a medium recording paper is conveyed through the fixing apparatus 20, are cooled by the cooling air blown onto them through the air outlets a and a of the left and right ducts 51L and 51R, which have been adjusted in width. Therefore, the problem that the portions of the fixation belt 33, which correspond to the out-of-sheet-path portions, which occur when a medium recording paper is conveyed through the fixing apparatus, increase in temperature when a substantial number of medium sheets of recording paper are continuously conveyed through the fixing apparatus, is prevented.

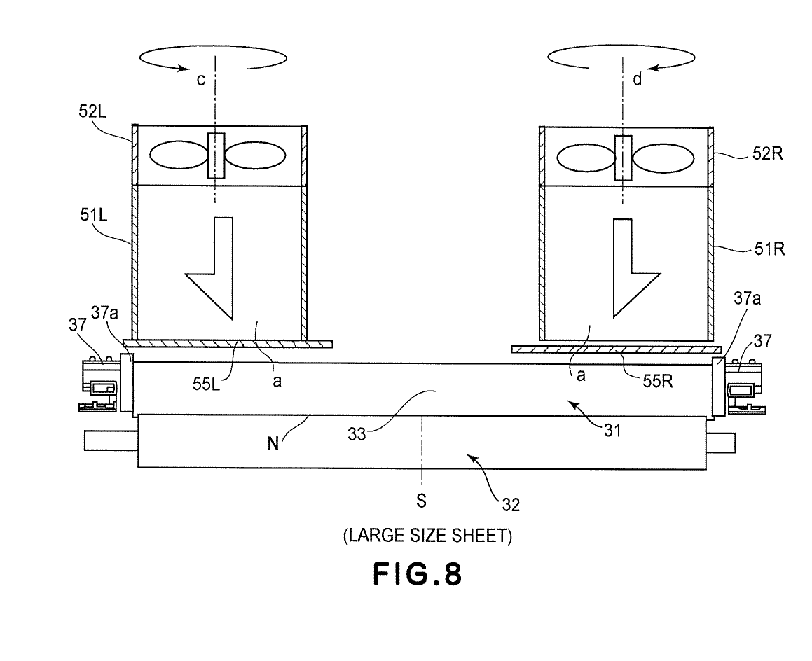

FIG. 8 is a schematic drawing of the fixing mechanism portion 20A in the state in which a large recording paper is being conveyed through the fixing apparatus 20. When the fixing mechanism portion 20A is in the state shown in FIG. 8, the out-of-sheet-path portion does not occur, and therefore, the problem that the portions of the fixation belt 33, which correspond to the out-of-sheet-path portions, increase in temperature does not occur. Therefore, the left and right shutter plates 55L and 55R are moved into the position in which they keep completely blocked the air outlets a and a of the left and right ducts 51L and 51R. Thus, the fixation belt 33 is not cooled by the cooling air. Incidentally, in this case, that is, when sheets of large recording medium are conveyed through the fixing apparatus 20, the fixing mechanism portion 20A may be controlled so that the cooling fans 52L and 52R are kept stationary. If the cooling fans 52L and 52R are kept stationary, the control for moving the left and right shutter plates 55L and 55R into the position in which they keep completely blocked the air outlets a and a of the left and right ducts 51L and 51R does not need to be executed.

As described above, the left and right shutter plates 55L and 55R are controlled so that they move to the positions which correspond to the width of the recording medium used for image formation. Thus, the width of the air outlets a and a of the left and right ducts 51L and 51R is adjusted to the optimum width, that is, the width matching the width of the sheet of recording medium used for the ongoing image forming operation. Therefore, the fixation belt 8 is optimally cooled by the forced draft cooling mechanism portion 20B; the fixation belt 8 is cooled by the forced draft cooling mechanism, with its air outlets matching in width the sheet of recording medium in use. More concretely, the right shutter plate 55R is provided with a rib 55a (FIGS. 1 and 5), which is formed by cutting and bending a small portion of the shutter frame 54. The rib 55a is provided with multiple smaller ribs b, the position of which is set according to the various recording medium sizes. Further, the shutter frame 54 is provided with a photosensor PH for detecting the smaller edges 55b. The photosensor PH is solidly fixed to the shutter frame 54. The information regarding the detection of the small ridges 55b by the photosensor PH is inputted into the control circuit portion 100 through an A/D converter 83. The control circuit portion 100 rotates the shutter motor M2 forward or in reverse, moving the left and right shutter plates 55L and 55R, so that one of the small ribs 55b, which matches the information regarding the recording medium size, which is inputted from the external host apparatus or the like, is detected by the photosensor PH. Then, as the small rib 55b, which matches the information regarding the width of the recording medium in use, is detected, the driving of the shutter motor M2 is stopped. As a result, the left and right shutter plates 55L and 55R are stopped at the positions, one for one, which correspond to the width of the recording medium in use.

Next, the operation of the left and right cooling fans 52L and 52R of the fixing apparatus 20 in this preferred embodiment will be described. As a substantial number of small or medium recording papers, that is, recording papers smaller than a large recording paper, are continuously conveyed for fixation through the fixing apparatus during an image forming operation, the portions of the fixation belt 33, which correspond to the out-of-sheet-path portions Ra and Rb, increases in temperature. The subordinate thermistor TH2, as the second temperature detecting means, detects the temperature of the portion of the inward surface of the fixation belt 33, which corresponds to one the out-of-sheet-path portions. The control circuit portion 100 (controller) checks whether or not the temperature detected by the subordinate thermistor TH2 has reached a preset level. As soon as it determines that the temperature has reached the preset level, it controls the shutter motor driver circuit 93 to move the shutter plates 55L and 55R to the positions which correspond to the width of the recording medium in use by the shutter motor M2. In addition, the control circuit portion 100 (controller) controls the cooling fan driver circuit 94 (FIG. 9) to start the left and right cooling fans 52L and 52R. As a result, the portions of the fixation belt 33, which correspond to the out-of-sheet-path portions Ra and Rb are prevented from excessively increasing in temperature. Then, as the temperature detected by the subordinate thermistor TH2 falls to a preset level, the control circuit portion 100 stops the cooling fans 52L and 52R.

The forced draft cooling mechanism portion 20B is controlled so that the level of the temperature detected by the subordinate thermistor TH2, at which the cooling fans 52L and 52R are turned on, and the level of the temperature detected by the subordinate thermistor TH2, at which the cooling fans 52L and 52R are turned off, are changed according to the condition under which the cooling fans operate.

The temperature range in which the cooling fans 52L and 52R are turned on or off in this embodiment is as follows: For example, in an image forming operation in which 100 sheets of recording paper of a size B4 (medium recording papers) are continuously conveyed through the fixing apparatus 20, the operation is controlled in the following manner. That is, while the first-30th sheets of recording paper are conveyed, the cooling fans 52L and 52R are started as the temperature detected by the subordinate thermistor TH2 reaches 200° C, whereas they are stopped as the temperature detected by the subordinate thermistor TH2 falls to 190° C. While the 31st-60th sheets of recording paper are conveyed, the cooling fans 52L and 52R are started as the temperature detected by the subordinate thermistor TH2 reaches 205° C., whereas they are stopped as the temperature detected by the subordinate thermistor TH2 falls to 195° C. For the 61st sheet of recording medium and thereafter, the temperature level at which the cooling fans are started, and the temperature level at which they are stopped, are raised by 5° C. for every 30th sheet of recording paper.

As described above, the rotational direction c of the cooling fan 52R is opposite to the rotational direction d of the cooling fan 52L, and the left and right ducts 51L and 51R are the same in shape, or symmetrically positioned relative to each other with respect to the referential centerline S. Thus, the flow of the air sent to the left out-of-sheet-path portion Ra, and the flow of the air sent to the right out-of-sheet-path portion Rb, are symmetrical in air speed distribution and flow line pattern, with respect to the referential centerline S. Therefore, the temperature distribution of the fixation belt 33 is symmetrical with respect to the center of the fixation belt 33 in terms of the lengthwise direction.

Also as described above, the flow of the air sent to the left out-of-sheet-path portion Ra, and the flow of the air sent to the right out-of-sheet-path portion Rb, are symmetrical in air speed distribution and flow line pattern, with respect to the referential centerline S. Therefore, in terms of the width direction, the end portions of the recording medium passage are the same in temperature. Therefore, unsatisfactory fixation does not occur. Further, the portions of the fixation belt 33, which correspond to the left and right out-of-sheet-path portions Ra and Rb, remain symmetrical in temperature distribution with respect to the referential centerline S. Therefore, it is unnecessary to provide both the portions of the fixation belt 33, which correspond to the out-of-sheet-path portions Ra and Rb, with the temperature detecting means TH2; it is only one of them that needs to be provided with the temperature detecting means TH2. Moreover, the temperature distribution of the fixation belt 33 is symmetrical with respect to the center of the fixation belt 33 in terms of the lengthwise direction. Therefore, the thermal expansion of the pressure roller 32 is also symmetrical with respect to its center in terms of the lengthwise direction. Therefore, a sheet of recording medium does not deviate to one side of the pressure roller 32, or the other, while being conveyed. Therefore, the fixing apparatus 20 in this embodiment is reliable in terms of fixation performance and recording medium conveyance.

This preferred embodiment eliminates the problem that the lengthwise ends of the rotational member (having heat source) become different in temperature, by making the air blown onto one end portion of the rotational member, that is, one of the portions of the rotational member, which corresponds to the out-of-sheet-path portion of the sheet conveyance passage, symmetrical relative to the air blown onto the other end portion, that is, the end portion of the fixation belt, which corresponds to the other out-of-sheet-path portion of the sheet conveyance passage. Therefore, the fixing apparatus in this embodiment does not suffer from the unsatisfactory fixation and the excessive increase in the temperature of the portions of the fixation belt, which correspond to the out-of-sheet-path portions, and therefore, can reliably convey recording medium. In particular, in the case of a thin belt employed for quick start and/or energy consumption reduction, it is small in thermal capacity. Therefore, the difference in velocity between the air flow directed to one of the end portions of the fixation belt and the air flow directed to the other is conspicuously reflected as the difference in cooling effect between the two air flows, by the temperature distribution of the belt. Thus, it may be said that when the forced draft cooling mechanism portion 20B is symmetrical in terms of the air speed distribution of the air flow directed to the lengthwise end portions of the belt, it is better in belt cooling performance.

### Embodiment 2

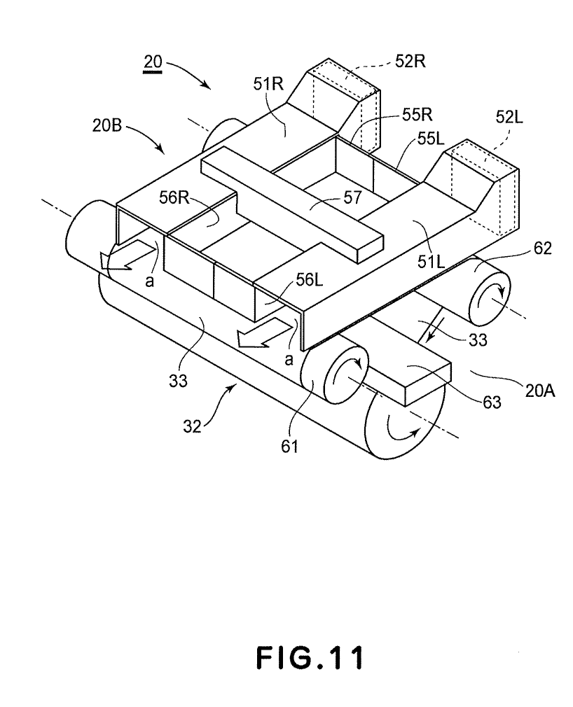

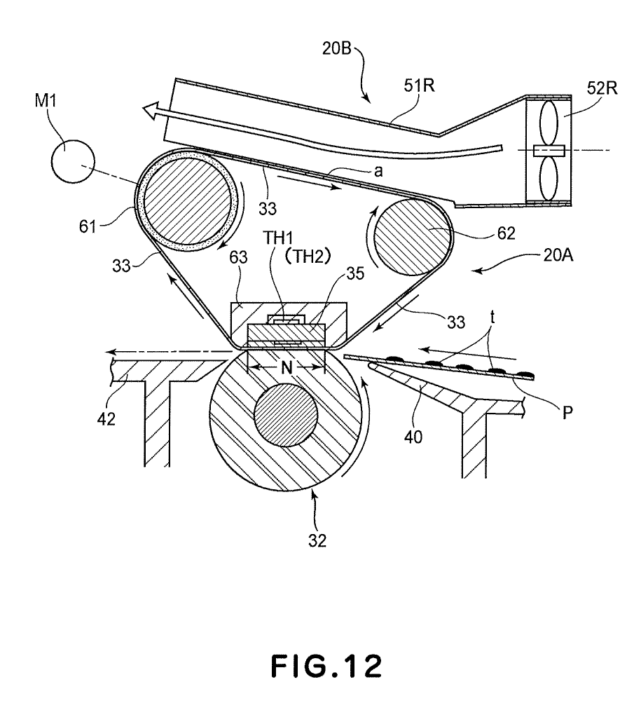

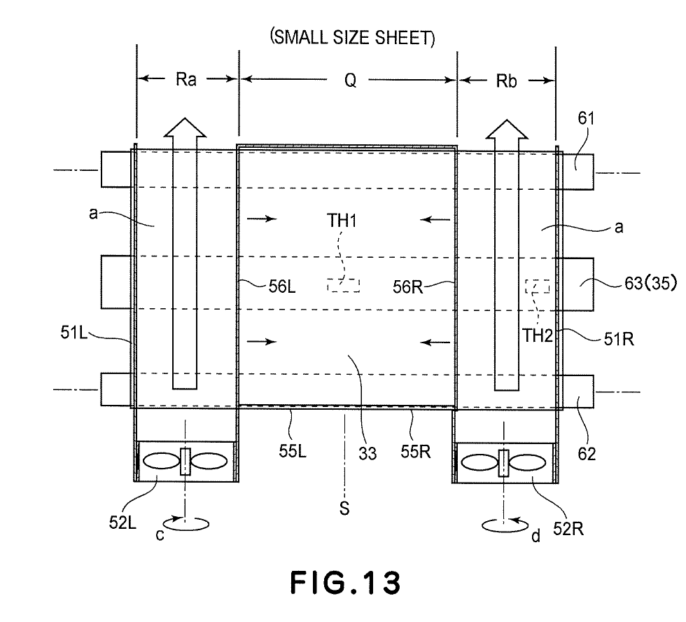

FIG. 11 is an external perspective view of the fixing apparatus 20 as the image heating apparatus in this embodiment, and FIG. 12 is a schematic cross-sectional view of the fixing apparatus 20. FIGS. 13-15 are schematic drawings showing the movement of the shutter plates.

The fixing apparatus 20 in this embodiment is roughly separable into a fixing mechanism portion 20A of the heating belt type, and a forced draft cooling mechanism portion 20B. The recording medium P is conveyed so that the centerline of the recording medium P coincides with the referential centerline of the recording medium passage of the fixing apparatus 20.

The fixing mechanism portion 20A in this embodiment is made up of a fixation belt 33, a driver roller 61, a follower roller 62, a heating member 35, and a heating member supporting member 63. The fixation belt 33, as a rotational heating member, is in the form of an endless belt. The driver roller 61 and follower roller 62 are arranged roughly in parallel with a preset distance. The heating member 35 is supported by the heating member supporting member 63. The fixation belt 33 is stretched around, and supported by, the driver roller 61, follower roller 62, and supporting member 63. The follower roller 62 also functions as the tension roller for the fixation belt 33. The heating member 35 is a ceramic heater, the lengthwise direction of which is perpendicular to the direction in which the fixation belt 33 and recording medium P move. Against this heater 35, an elastic pressure roller 32 is kept pressed, with the presence of the fixation belt 33 between the heater 35 and pressure roller 32, forming thereby a fixation nip N. The driver roller 61 is rotationally driven by a fixation motor M1 in the clockwise direction indicated by an arrow mark in FIG. 12. As the driver roller 61 is rotationally driven, the fixation belt 33 is rotationally driven in the counterclockwise direction indicated by an arrow mark. The follower roller 62 and pressure roller 32 are rotated by the rotation of the fixation belt 33. The fixation belt 33 slides on the heater 35 and heater supporting member 63, with its inward surface remaining in contact therewith.

As electric current is flowed by a heater driver circuit through the heat generation layer of the heater, which is on the surface of the heater substrate, the heat generation layer generates heat. As a result, the heater 35 quickly increases in temperature across the entirety of its effective heat generation range in terms of its lengthwise direction. The temperature of the heater 35 is detected by the main and subordinate thermistors TH1 and TH2, as the first and second temperature detecting means, respectively. In terms of the lengthwise direction of the heater 35, the main thermistor TH1 is placed in contact with roughly the center of the rear surface of the heater 35 to detect the temperature of the portion of the heater which remains within the recording medium path regardless of recording medium size. The subordinate thermistor TH2 is placed in contact with one of the lengthwise end portions of the heater 35 to detect the temperature of the portion of the heater 35 which corresponds to the portion of the recording medium passage, which is outside the path of a recording medium narrower than the path of a widest recording medium conveyable through the fixing apparatus 20. The electrical information regarding the temperature detected by the main thermistor TH1 is inputted into the control circuit portion through an A/D converter. Further, the temperature of the fixation belt 33 is detected by the subordinate thermistor TH2, and the electrical information regarding this temperature of the fixation belt 33 is inputted into the control circuit portion through an A/D converter. The control circuit portion sets up a proper procedure for adjusting the temperature of the heater 35 based on the outputs of the main and subordinate thermistors TH1 and TH2, in order to control the amount of electric power supplied to the fixation heater 35 from the heater driver circuit. That is, the temperature of the fixation heater 35 is controlled so that the heater temperature detected by the main thermistor TH1 is maintained at a preset fixation temperature level.

Then, the control circuit portion starts to rotationally drive the driver roller 61 by controlling the fixation motor driving circuit for the fixation motor M1 in response to a print start signal from an external host apparatus, or a control signal other than the print start signal. The control circuit portion also starts up the heater 35 by controlling the heater driver circuit. As soon as the fixation belt 33 stabilizes in circulatory speed, and the temperature of the heater 35 reaches the preset level, the recording medium P bearing an unfixed toner image t is guided into the fixation nip portion N along the entrance guide 40 from the direction of the image forming portion, with the toner image bearing surface of the recording medium P facing the fixing belt 33. The recording medium P, and the portion of the fixation belt 33, which corresponds to the recording medium P, move together through the fixation nip N, with the recording medium P kept pressed against the heater 35, with the presence of the fixation belt 33 between the heater 35 and recording medium P. While the recording medium P is conveyed through the fixation nip N, the recording medium P is given heat by the fixation belt 33 which is being heated by the heater 35. As a result, the toner image t on the recording medium P is thermally fixed to the surface of the recording medium P. After the conveyance of the recording medium P through the fixation nip N, the recording medium P is separated from the surface of the fixation belt 33, and is conveyed further along an outlet guide 42 to be discharged from the apparatus main assembly.

The forced draft cooling mechanism portion 20B is provided with first and second cooling means. The first cooling means is provided with a left duct 51L and a left cooling fan 52L. The left duct 51L is structured and positioned so that its air outlet faces the adjacencies of the left lateral edge of the outward surface of the fixation belt 33. The left cooling fan 52L sends the cooling air into the left duct 51L. The second cooling means is provided with a right duct 51R and a right cooling fan 52R. The right duct 51R is structured and positioned so that its air outlet faces the adjacencies of the right lateral edge of the outward surface of the fixation belt 33. The right cooling fan 52R sends the cooling air into the right duct 51R.

The left and right ducts 51L and 51R, respectively, are structured and position so that they extend from the follower roller 62 side to the driver roller 61 side. Their bottom side, that is, the side which faces the fixation belt 33 is open, functioning as the cooling air outlet. Further, the left and right ducts 51L and 51R are also open on the driver roller 61 side, and these openings function as cooling air release openings. The left and right cooling fans 52L and 52R are in the opposite ends of the left and right ducts 51L and 51R from the cooling air release openings, respectively.

The left and right ducts 51L and 51R are provided with inward lateral plates 56L and 56R, respectively, which are slidable in the lengthwise direction of the fixation belt 33. The portion of the inward lateral plate 56L of the left duct 51L, which is on the cooling fan 52L side, is bent inward, roughly perpendicular to the rest of the inward lateral plate 56L, and functions as a left shutter plate 55L. The portion of the inward lateral plate 56R of the right duct 51R, which is on the cooling fan 52R side, is also bent inward, roughly perpendicular to the rest of the inward lateral plate 56R, and functions as a right shutter plate 55R. The left lateral plate 56L having the shutter plate 55L, and the right lateral plate 56R having the shutter plate 55R, are movable by a shutter sliding mechanism 57, that is, a mechanism for slidably moving the shutter plates 55L and 55R (lateral plates 56L and 56R) to increase or reduce in width the air outlets a and a of the left and right ducts 51L and 51R. The movement of the shutter plates 55L and 55R (lateral plates 56L and 56R) are controlled so that the air outlets a and a of the left and right ducts 51L and 51R remain equal in width.

The control circuit portion moves the left lateral plate 56L having the shutter plate 55L, and the right lateral plate 56R having the shutter plate 55R, to the positions which correspond to the width of the recording medium in use, by controlling the shutter sliding mechanism 57 in response to the information regarding the width of the recording medium in use. That is, the control circuit portion controls the shutter sliding mechanism 57 according to the width of the recording medium which is conveyed through the fixation nip N, so that the width of the air outlet of each of the cooling fans 52L and 52R becomes optimal for the portion of the fixation belt, which needs to be cooled.

The left and right ducts 51L and 51R are positioned so that their centerlines are roughly perpendicular to a plane O-O (FIG. 6), which corresponds to the flat portions of the fixation belt 33. The left and right ducts 51L and 51R are the same in shape, or symmetrically shaped with respect to the referential centerline S (centerline of fixation belt 33 in terms of lengthwise direction). The left and right cooling fans 52L and 52R are axial flow fans. The rotational direction d of the blades of the right cooling fan 52R is opposite to the rotational direction c of the blades of the left cooling fan 52L. Although the left and right cooling fans 52L and 52R are opposite in the direction in which their blades rotate, they are the same in the output direction (air flow direction), and also, roughly the same in performance.

FIG. 13 is a schematic sectional view of the forced draft cooling mechanism portion in the state in which small sheets of recording medium (narrowest recording medium conveyable through fixing apparatus) are continuously conveyed. In FIG. 13, designated by a referential letter Q is the path of a small recording paper, and designated by referential letter combinations Ra and Rb are the left and right out-of-sheet-path portions of the recording medium passage of the fixing apparatus 20, which are on the left and right sides of the recording paper path Q, or the path of a small recording paper. The air outlets a and a of the left and right ducts 51L and 51R correspond to the left and right out-of-sheet-path portions Ra and Rb. The widths of the air outlets a and a of the left and right ducts 51L and 51R are the same as those of the left and right out-of-sheet-path portions Ra and Rb, respectively.

Further, when the fixing mechanism portion 20A is in the state shown in FIG. 13, the left lateral plate 56L having the shutter plate 55L, and the right lateral plate 56R having the shutter plate 55R, are in the positions in which they keep fully open the air outlets a and a of the left and right ducts 51L and 51R. Thus, the portions of the fixation belt 33, which correspond to the left and right out-of-sheet-path portions Ra and Rb, which occur when a small recording paper is conveyed through the fixing apparatus 20, are cooled by the cooling air blown onto them through the air outlets a and a of the left and right ducts 51L and 51R, which are fully open. Therefore, the problem that the portions of the fixation belt 33, which correspond to the out-of-sheet-path portions, which occur when a small recording paper is conveyed through the fixing apparatus, increase in temperature when a substantial number of small sheets of recording paper are continuously conveyed through the fixing apparatus, is prevented.

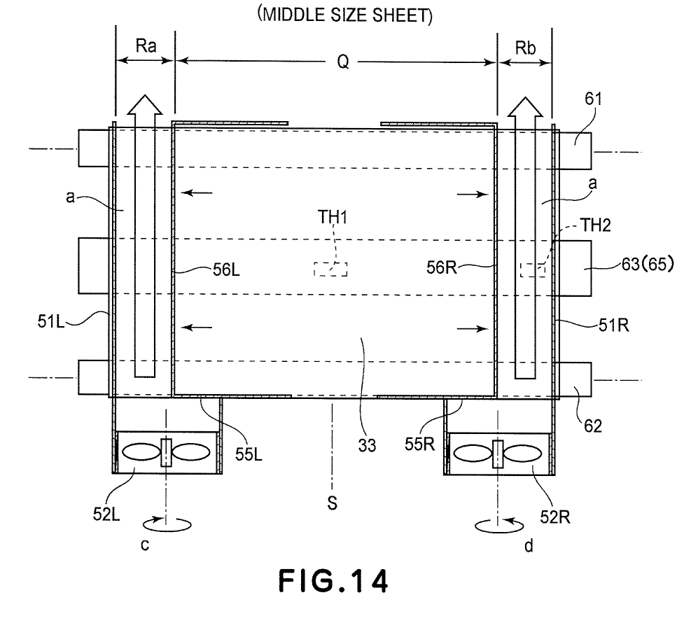

FIG. 14 is a schematic drawing of the forced draft cooling mechanism portion 20B in the state in which a medium recording paper (recording paper whose size is between size of widest recording paper conveyable through fixing apparatus and size of narrowest recording paper conveyable through fixing apparatus) is being conveyed through the fixing apparatus. Referring to FIG. 14, designated by a referential letter Q is the path of a medium recording paper, and designated by referential letter combinations Ra and Rb are the left and right out-of-sheet-path portions of the recording medium passage of the fixing apparatus, which are on the left and right sides of the recording paper path Q, or the path of a medium recording paper. The left lateral plate 56L having the shutter plate 55L, and the right lateral plate 56R having the shutter plate 55R, are moved to reduce in width each of the air outlets a and a of the left and right ducts 51L and 51R; they are moved to the positions which correspond to the width of the recording medium. Thus, the portions of the fixation belt 33, which correspond to the left and right out-of-sheet-path portions Ra and Rb, which occur when a medium recording paper is conveyed through the fixing apparatus, are cooled by the cooling air blown onto them through the air outlets a and a, which have been adjusted in width. Therefore, the problem that the portions of the fixation belt, which correspond to the out-of-sheet-path portions of the record medium passage of the fixing apparatus, which occur when a medium recording paper is conveyed through the fixing apparatus, increase in temperature when a substantial number of medium sheets of recording paper are continuously conveyed through the fixing apparatus, is prevented.

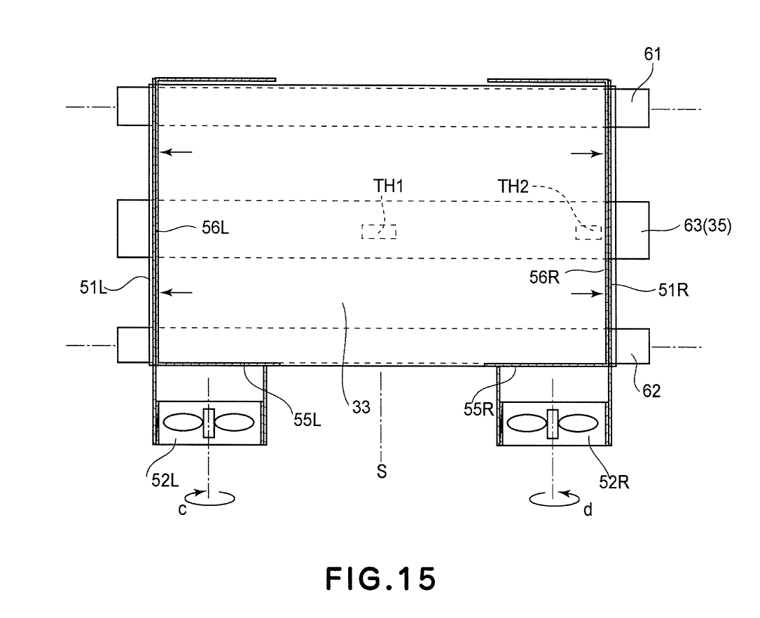

FIG. 15 is a schematic drawing of the forced draft cooling mechanism portion 20B in the state in which a large recording paper (widest recording paper conveyable through fixing apparatus) is being conveyed through the fixing apparatus 20. When the forced draft cooling mechanism portion 20B is in the state shown in FIG. 15, the out-of-sheet-path portion does not occur to the recording medium passage of the fixing apparatus, and therefore, the problem that the portions of the fixation belt, which correspond to the out-of-sheet-path portions, increase in temperature does not occur. Therefore, the left lateral plate 56L having the shutter plate 55L, and the right lateral plate 56R having the shutter plate 55R, are moved to the positions in which they keep completely shut the air outlets a and a of the left and right ducts 51L and 51R. Thus, the fixation belt 33 is not cooled by the cooling air. Incidentally, in this case, that is, when sheets of large recording medium are conveyed through the fixing apparatus 20, the forced draft cooling mechanism portion 20B may be controlled so that the cooling fans 52L and 52R are kept stationary. If the cooling fans 52L and 52R are kept stationary, the control for moving the left and right shutter plates 55L and 55R into the position in which they keep completely blocked the air outlets a and a of the left and right ducts 51L and 51R does not need to be executed.

As the temperature detected by the subordinate thermistor TH2 matches a preset level, the control circuit portion moves the left lateral plate 56L having the shutter plate 55L, and the right lateral plate 56R having the shutter plate 55R, to the positions which correspond to the width of the recording medium in use, by controlling the shutter sliding mechanism 57. Further the control circuit portion starts the left and right cooling fans 52L and 52R by controlling the cooling fan driver circuit. Therefore, the problem that the portions of the fixation belt, which correspond to the out-of-sheet-path portions excessively increase in temperature is prevented. Then, as the temperature detected by the thermistor TH2 falls to a preset level, the control circuit portion stops the cooling fans 52L and 52R.

The effects of the fixing apparatus in this second embodiment are the same as those of the fixing apparatus in the first embodiment.

### Miscellaneous Embodiments

1) The left and right cooling fans 52L and 52R in the first and second embodiments may be replaced with a pair of blower fans, or the like, which are symmetrical in air speed distribution, and also, in rotor rotation direction, with respect to the centerline of the fixation belt 33 in terms of the lengthwise direction.

2) The application of the present invention is not limited to a fixing mechanism, such as the fixing mechanism portion 20A, in the first and second embodiments, in which an unfixed image is fixed by a heated fixation belt, and the fixation belt is driven by driving a rotational pressure applying member. That is, the present invention is also effectively applicable to various types of a fixing apparatus other than the above described ones, for example, a fixing apparatus of the heat roller type, that is, a fixing apparatus made up of a heat roller which is rotated by a driving means, and is heated by a halogen lamp, or the like, and a pressure roller kept pressed upon the heat roller, and a fixing apparatus employing a heating method based on electromagnetic induction.

Not only is an image heating apparatus in accordance with the present invention usable as a fixing apparatus such as those described above, but also, as a glossiness increasing apparatus, or the like, for heating a fixed image on recording medium in order to increase the image in glossiness.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 204661/2006 filed Jul. 27, 2006, which is hereby incorporated by reference.

What is claimed is:

1. An image heating apparatus comprising:
a heating rotatable member for heating an image on the recording material in a nip; and
a first fan and a second fan for cooling one and the other and portions of said the heating rotatable member with respect to a rotational axis of said the heating rotatable member, respectively,
wherein rotational directions of said first fan and said second fan are opposite from each other.

2. An apparatus according to claim 1, further comprising a first duct for guiding air from said first fan to said heating rotatable member and a second duct for guiding air from said second fan to said heating rotatable member, wherein said first and second ducts have configurations which are symmetrical with respect to the rotational axis.

3. An apparatus according to claim 1, father comprising a detector for detecting a temperature of said heating rotatable member adjacent said one end portion, and a controller for operating said first fan end of said second fan when said detector detects a predetermined level of the temperature.

4. An apparatus according to claim one, wherein said first fan and said second fan are axial fan.
